(19) United States
(12) Patent Application Publication
(10) Pub. No.: US 2003/0121910 A1
(43) Pub. Date: Jul. 3, 2003

(54) Mail sanitizer and method

(76) Inventor: Louis Rey, El Paso, TX (US)

Correspondence Address: Soules & Wallare, P.C., Attn: Janice Leverett, Suite 1500, 100 W. Houston Street, San Antonio, TX, 78205, US

(21) Appl. No.: 10/039,182

(22) Filed: Jan. 3, 2002

(51) Int. Cl. H05B 6/80

(52) U.S. Cl. 219/678; 219/756; 422/21

(57) ABSTRACT

A mail sanitizer and method utilizing microwaves capable of treating biologically and/or chemically contaminated mail items, packages and the like. The mail sanitizer includes a cavity positioned inside a plurality of walls and a door. An activation display mounted on one of the walls allows a user to activate the mail sanitizer, either by manual operation, remote control or timer, allowing microwaves to enter and treat the mail items.

### TECHNICAL FIELD

The present invention relates to a mail sanitizer and method of utilizing microwaves to analyze and treat articles, in particular contaminated mail, packages and the like.

### BACKGROUND OF THE INVENTION

Since Sep. 11, 2001, the United States and undisclosed territories have been under the threat of Anthrax scares and some mail recipients' have had physical contact contamination from mail, packages or the like being disseminated through the Post Office system. As a result, many mail recipients have resorted to either not opening mail items, returning the mail back to the original sender, immediately discarding mail without examining the mail item's contents or using surgical gloves during the process of opening the mail.

In the past when articles become contaminated, various chemical means are often used to decontaminate and render the article safe such as using disinfectant sprays. However, an inexpensive way to sterilize an item is the application of heat. The use of radiation such as gamma rays, ultra violet ray and microwaves have been used to sterilize items such as food products, liquid or semi-liquid filled packages and the like.

An example of using microwaves is shown in EPO No. 0344408 issued to Barilla G.E.R. Fratelli in 1989. This European patent describes a method for stabilizing pre-packaged food products while sanitizing food containers using microwaves in an atmosphere where hot air is maintained at a superatmospheric pressure. Specifically, the food products are heated to a predetermined heating temperature in a processing zone; keeping the food products at the attained heating temperature in a second processing zone; and cooling the food products in a cooling zone at a superatmospheric pressure. Further, the European method describes the food products being moved through the processing and cooling zones continuously at a speed which is selected according to the residence times set to attain the predetermined temperatures. However, although the abovementioned patent provides for strictly stabilizing food products, it does not provide for treating biological and/or chemical contaminants in mail items.

As technology advanced, society became accustomed to machines used to disinfect articles. An example of a disinfecting device is shown in U.S. Pat. No. 5,140,136 issued to Fellows in 1992. The '136 patent provides for a method and container for the disinfection of articles by heat. The container has a void and a heating element incorporated in the void having a fabric containing resistance wires woven therein; and a hinged lid mounted on the container. Here, the heating element is in intimate contact with an article placed thereon via a resiliently deformable pad. However, the '136 patent does not protect a mail item from becoming burned since it would be placed in direct contact with the heating element.

In view of the above deficiencies associated with the use of disinfection devices, the present invention has been developed to alleviate these drawbacks and provide further benefits to the user as well as society as a whole. These enhancements and benefits are described in greater detail herein below with respect to several alternative embodiments of the present invention.

### SUMMARY OF THE INVENTION

The present invention in its several disclosed embodiments alleviates the drawbacks described above with respect to conventional disinfection devices and incorporates several additionally beneficial features. The present invention is a mail sanitizer having a cavity interiorly positioned between a plurality of walls and a door. The door is distally opposed to a rear wall and has a handle attached thereon and a safety catch desirably located on a bottom portion of the door. The rear wall has an electrical attachment incorporated therein and a bottom wall preferably mounted upon a base.

One of the side walls has an activation display having at least one button capable of being depressed by a user and an operational indicator displaying when the mail sanitizer is in use. In a preferred embodiment, the activational display includes a sensor receiving signals from a control instrument. In an alternative embodiment, the activation display includes a timer capable of being set at a predetermined or variable period of time. Further, a ventilation system is incorporated on any of the walls, allowing heat generated within the cavity to escape through the vents and into the atmosphere.

The present invention also includes a method of disposing a mail item within the cavity of the mail sanitizer and closing the door creating a closed seal. When the activation display is triggered, microwaves are emitted into the cavity, preferably ranging at a frequency between 2000 to 3600 megahertz, and are absorbed by the biological and/or chemical contaminants contained inside the mail item. When the microwaves have ceased either by manual direction, timer or remote control, the user will access the cavity by engaging the door handle.

It is therefore a goal of the present invention to impart a sense of safety to a user's life and health by providing a mail sanitizer that allows the user to destroy contaminants inside various mail items without burning the mail items themselves. As a result, the present invention allows a user to view contents of the mail item without becoming infected. Thus, the present invention reduces health scares by killing biological and/or chemical contaminants in the mail item. Specifically, the mail sanitizer is able to accept various mail items ranging in size such as from an envelope to a package. Further, the present invention may be for commercial or residential uses and is easy to manufacture.

Another advantage of the present invention is to provide a mail sanitizer having an activation display capable of activating the influx of microwaves therein. The activation display may be configured to operate by a number of devices such as by: (1) manual depression of buttons; (2) a remote control; or (3) a timer.

A further advantage of the present invention is the heat-resistant base mounted underneath the lower wall of the mail sanitizer in order to protect a tabletop or shelf s surface.

Further advantages of the invention will be more clearly understood from the following description of illustrative embodiments thereof, to be read by way of example and not of limitation in conjunction with the apparatus and method shown schematically in the accompanying drawing.

### BRIEF DESCRIPTION OF THE DRAWINGS

The invention will now be described in greater detail in the following way of example only and with reference to the attached drawings, in which:

FIG. 1 is an isometric view of a mail sanitizer incorporating an operational panel used to employ microwaves capable of treating items inserted therein.

FIG. 2 is a front view of the present invention depicting the mail sanitizer having a door with a handle and safety catch positioned thereon.

FIG. 3 is a schematic view of a method for using the mail sanitizer.

### MODE(S) FOR CARRYING OUT THE INVENTION

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

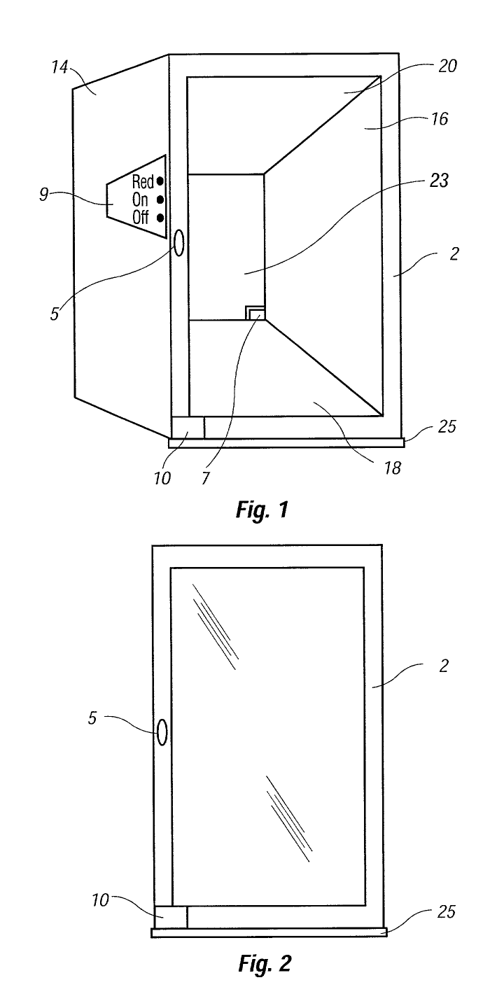

FIG. 1 depicts a mail sanitizer 1 collectively including a cavity 28 interiorly positioned between a top wall 20, a bottom wall 18, side walls 14, 16, a rear wall 23, and a door 2. Specifically, the cavity 28 is capable of receiving items, namely mail items, packages and the like ranging in size, thickness and types of envelope or package paper ranging from cellulose paper to cotton and/or linen fabric paper. The rear wall 23 incorporates an electrical attachment 7 capable of being connected by a cord-to-socket or to a battery pack. The bottom wall 18 may be adjacently mounted upon a base 25, whereby the base 25 is preferably made from any insulating and heat-resistant material such as plastic, aluminum, rubber and the like.

The door 2 is distally opposed to the rear wall 23 and is hingedly fastened to either the side wall 14, 16, top wall 20 or bottom wall 18. Specifically, as shown in FIG. 2, the door 2 has a handle 5 operatively connected thereon and a safety catch 10 preferably positioned towards a bottom portion of the door 2. In an alternative embodiment, the safety catch 10 may be located on the bottom wall 18 or base 25 and extending vertically towards the door 2.

One of the side walls 14, 16 has an activation display 9 attached thereon. The activation display 9 includes an on 11 and an off 12 button, both capable of being depressed by a user, and an operational indicator 13 depicting when the mail sanitizer 1 is in use. Specifically, the operational indicator 13 houses a light, preferably red, therein being illuminated through a translucent covering. In the most preferred embodiment, the activational display 9 incorporates a sensor (not shown) therein receiving translated infrared light signals from a remote control (not shown) or other control instrument including a printed circuit board and a transformer to the display 9 itself.

In an alternative embodiment, the activation display 9 also incorporates a timer (not shown) capable of being set at a predetermined or variable period of time. Operatively speaking, when the time indicated on the timer has elapsed, the light on the operational indicator 13 will terminate indicating that microwaves are no longer active within the mail sanitizer 1.

In a most preferred embodiment, a ventilation system having vents (not shown) is included on any of the walls, namely the side walls 14, 16, top wall 20 or rear wall 23, allowing heat generated within the cavity 28 to escape through the vents and into the atmosphere.

Operatively speaking, FIG. 3 depicts the method of a mail item being disposed within the cavity 28 of the mail sanitizer 1 and being enclosed by the door 2 creating a closed seal. When the activation display 9 is triggered, microwaves are emitted into the cavity 28, preferably ranging at a frequency between 2000 to 3600 megahertz, and are absorbed by the biological and/or chemical contaminants contained therein. When the microwaves have ceased either by manual direction, timer or remote control, the user will access the cavity 28 by engaging the door handle 5.

### INDUSTRIAL APPLICABILITY

The present invention finds specific industrial applicability in the post office and related mailing distribution industries.

What is claimed and desired to be secured by letters patent is as follows:

1. An apparatus for sanitizing mail items comprising:
a mail sanitizer having a cavity interiorly positioned within a plurality of walls and at least one door;
a handle being mounted upon said door;
an activation display attached to one of said walls and being in electrical communication with said mail sanitizer; and
an electrical attachment connected to one of said walls.

2. The apparatus as recited in claim 1, further comprising a safety catch positioned upon said door.

3. The apparatus as recited in claim 1, further comprising a base located underneath a lower wall of said mail sanitizer.

4. The apparatus as recited in claim 1, wherein said activation display comprises an operational button, an on button and an off button.

5. The apparatus as recited in claim 1, wherein said electrical attachment is connected to a battery.

6. The apparatus as recited in claim 1, wherein said electrical attachment is in communication with an electrical cord.

7. The apparatus as recited in claim 1, wherein said activation display incorporates a sensor being in infrared communication with a remote control.

8. The apparatus as recited in claim 1, wherein said activation display further comprising a timer being set on a predetermined period of time.

9. A method of sanitizing mail items comprising the steps of:
disposing a mail item into a cavity and creating a seal,
activating a display having incorporated controls at a set frequency,
emitting microwaves into said cavity for a period of time, and
retrieving said mail item from said cavity.

10. The method of sanitizing mail items as recited in claim 9, wherein said activating a display is by manual depression of said controls.

11. The method of sanitizing mail items as recited in claim 10, wherein said activating a display is by triggering a timer.

12. The method of sanitizing mail items as recited in claim 10, wherein said activating a display by utilizing a remote control.

13. The method of sanitizing mail items as recited in claim 10, wherein said frequency ranges between 2000 to 3600 megahertz.
